(19) United States
(12) Patent Application Publication
(10) Pub. No.: US 2025/0001801 A1
(43) Pub. Date: Jan. 2, 2025

(54) Wheel Hub for a Commercial Vehicle Drive Axle

(71) Applicant: ZF Friedrichshafen AG, Friedrichshafen (DE)

(72) Inventors: Thomas Bergmann, Lappersdorf (DE); Thomas Waim, Grafenau (DE)

(21) Appl. No.: 18/756,774

(22) Filed: Jun. 27, 2024

(30) Foreign Application Priority Data
Jun. 28, 2023 (DE) 102023206072.8

(51) Int. Cl. B60B 27/06; B60B 27/00

(52) U.S. Cl. CPC B60B 27/065; B60B 27/0021

(57) ABSTRACT

A wheel hub for a utility vehicle drive axle includes a hollow section extending between a first axial end and a second axial end. The hollow section has centering sections defining a centering outer diameter of the hollow section for centering at least one wheel rim on the hollow section. The centering sections are separated from one another in the circumferential direction by intermediate sections, each of the intermediate sections being radially recessed relative to the centering sections. The intermediate sections are formed by machining the hollow section between the centering sections. The wheel hub has a flange section transitioning from the first axial end of the hollow section, the flange section projecting radially outwards relative to the hollow section, with the at least one wheel rim being couplable to the flange section.

### CROSS-REFERENCE TO RELATED APPLICATION

The present application is related and has right of priority to German Patent Application No. 10 2023 206 072.8 filed on Jun. 28, 2023, the entirety of which is incorporated by reference for all purposes.

### FIELD OF THE INVENTION

The invention relates generally to a wheel hub for a utility or “commercial” vehicle drive axle, the wheel hub having a hollow section which transitions at a first axial end into a flange section, the flange section projecting radially outwards relative to the hollow section and is provided for the fastening of at least one wheel rim, wherein the hollow section is provided in the region of the first axial end with centering sections which define a centering outer diameter of the hollow section for centering the at least one wheel rim on the hollow section and which are separated from one another in the circumferential direction by intermediate sections, each intermediate section being radially set back relative to the centering sections. The invention also relates generally to a utility vehicle drive axle having aforementioned wheel hubs.

### BACKGROUND

In drive axles of motor vehicles, it is typical to couple drive shafts within the associated drive axle to one associated wheel hub each, the wheel hubs being used for the mounting of at least one associated vehicle wheel in each case. In utility vehicle drive trains, wheel hubs are formed as bell hubs in some cases. Two vehicle wheels, as dual tires, are often mounted on one bell hub. To this end, a bell hub usually has a hollow section and a flange section. The vehicle wheel(s) are placed on the hollow section and fastened on the flange section. A bell hub is also usually used to accommodate a wheel hub drive, via which an additional transmission ratio is achievable in the power path between the individual drive shaft and the vehicle wheel(s) mounted on the bell hub, and which is often configured as a planetary transmission. DE 10 2008 014 105 A1 describes a wheel hub which is a cast part and is composed of a hollow section and a flange section. A transition from the hollow section into the flange section is completed at one axial end of the hollow section. The flange section projects radially outwards relative to the hollow section and is used for the fastening of at least one wheel rim of one vehicle wheel each. At the axial end and thus directly in the region of the transition of the hollow section into the flange section, in addition, the hollow section is equipped with centering sections, which define a centering outer diameter of the hollow section. Intermediate sections are formed in the circumferential direction between the centering sections, separating the centering sections from one another in the circumferential direction, and are each radially set back relative to the centering sections.

### SUMMARY OF THE INVENTION

On the basis of the above-described prior art, the problem addressed by the present invention is that of creating a wheel hub which is characterized by low manufacturing outlay.

According to the invention, a wheel hub has a hollow section, which transitions at a first axial end into a flange section, which projects radially outwards relative to the hollow section and is provided for the fastening of at least one wheel rim. The hollow section is provided at the first axial end with centering sections which define a centering outer diameter of the hollow section for centering the at least one wheel rim on the hollow section and are separated from one another in the circumferential direction by intermediate sections, each of which is radially set back relative to the centering sections.

The wheel hub according to the invention therefore has a hollow section and a flange section, which axially adjoin one another by way of the hollow section transitioning at a first axial end into the flange section. The flange section projects radially outwards relative to the hollow section and is used for the fastening of at least one wheel rim on the wheel hub. For this fastening, the flange section, as well as the hollow section, are, in particular, circumferential, wherein the flange section is additionally preferably provided with mounting points, such as through-holes, which are spaced apart from one another, in particular equidistantly, in the circumferential direction, and through each of which a wheel bolt is inserted for fastening the at least one wheel rim. Therefore, the flange section of the wheel hub is preferably designed to be bolted to the at least one wheel rim in order to fasten the wheel rim on the wheel hub.

Within the framework of the invention, “axial” is to be understood as a parallel extension relative to an axis of rotation, while “radial” is to be understood within the framework of the invention as an extension in the direction of the diameter having a center situated on the axis of rotation.

The hollow section of the wheel hub is a hollow-body-shaped section of the wheel hub, and the hollow section is preferably shaped as a hollow cylinder or is a type of hollow cylinder.

In the region of the first axial end, at which the hollow section transitions into the flange section, in addition, a centering outer diameter is defined. This centering outer diameter is provided for centering the at least one wheel rim, which is to be fastened to the wheel hub, on the hollow section and thus also relative to the flange section. The centering outer diameter is defined via centering sections which are formed on the axial end of the hollow section and are separated from one another by intermediate sections, which are located between each centering section and the next in the circumferential direction. Therefore, in the region of the first axial end, centering sections and intermediate sections alternate with each other in the circumferential direction of the hollow section.

The intermediate sections are radially set back relative to the centering sections, i.e., situated on an outer diameter of the hollow section that is smaller in comparison to the centering outer diameter. As a result, a contact surface, at which contact takes place between a wheel rim fastened to the flange section and the hollow section, is correspondingly reduced, since this contact surface is interrupted in the circumferential direction by the intermediate sections. As a further consequence thereof, a region in which the wheel rim can corrode in place on the hollow section of the wheel hub is correspondingly reduced, as a result of which the wheel rim is more easily detachable from the wheel hub.

Within the meaning of the invention, the wheel hub is preferably formed in one piece, and therefore the hollow section and the flange section are also sections of the same component.

The invention now encompasses the technical teaching that the intermediate sections have been formed by machining the hollow section between the centering sections. In other words, the intermediate sections, which are situated between the centering sections in the circumferential direction and are radially set back relative to the centering sections, have been produced by way of machining having been carried out in the regions between the centering sections.

Such an embodiment of a wheel hub has the advantage that, as a result, the radially set back intermediate sections are formed with low manufacturing outlay, and simultaneously with great accuracy. Therefore, a reduction of the contact surface between the wheel rim, which is fastened to the flange section, and the hollow section is achieved in a simple and simultaneously reliable manner. In addition, this is also easily carried out retroactively, i.e., with a wheel hub which has already been produced and may even have already been used.

Within the meaning of the invention, “machining” is to be understood as a machining of the wheel hub according to the invention, in which the intermediate sections of the hollow section are produced in a chip-removing manner, i.e., the intermediate sections are defined by removing excess material as chips by mechanical removal. Therefore, the intermediate sections, which are radially set back relative to the centering sections, have been produced only within the framework of a machining of the wheel hub and thus have not been produced in a shaping or primary shaping manner.

According to one embodiment of the invention, the hollow section transitions at a second axial end, which is opposite the first axial end, into a base section, which extends radially inward from the hollow section and, together with the hollow section, delimits an interior. As a result, the wheel hub is given a pot-like shape, and therefore the wheel hub is of the bell hub type.

In one development of the aforementioned embodiment, projections which project axially in the interior are formed on the base section, the projections being provided for guiding one planet gear of a planetary gear set each. As a result, the wheel hub according to the invention is at least a portion of a planet carrier of the planetary gear set, the components of which are preferably accommodated in the interior, which is delimited by the base section and the hollow section. Advantageously, as a result, when the wheel hub according to the invention is used in a utility vehicle drive axle, a compact configuration of the utility vehicle drive axle is achieved by a planetary gear set being integrated, as a wheel hub drive, into the wheel hub and an additional transmission ratio being implemented in a power path between an associated drive shaft and the vehicle wheel(s) mounted on the wheel hub. Due to the separation of the centering sections of the wheel hub by the intermediate sections situated between the centering sections, detaching a wheel rim of the mounted vehicle wheel(s) from the wheel hub in the case of corrosion is also simplified.

According to one design option of the invention, an outer diameter of the hollow section reduces from the centering outer diameter toward a second axial end which is opposite the first axial end. As a result, it is made easier to slide a wheel rim, which is to be fastened to the flange section, onto the wheel hub, wherein the outer diameter of the hollow section is preferably reduced, in combination with the preceding variant, to a diameter at the second axial end, which is only slightly smaller than the centering outer diameter. As a result, it is ensured that the interior is sufficiently dimensioned to accommodate the planetary gear set. The outer diameter is reduced, in particular, linearly, as a result of which the hollow section has a tapered, or slightly tapered, shape. It is particularly preferred when the hollow section is shaped substantially as a hollow cylinder.

In one development of the invention, the centering sections and the intermediate sections are axially formed on the hollow section in a region, in which the at least one wheel rim is to be placed on the hollow section in order to be fastened to the flange section. This region, in which the centering sections and the intermediate sections alternate with each other in the circumferential direction, is directly axially adjacent to the flange section or spaced apart from the flange section via an axially intermediate region of the hollow section. It is essential that the centering sections and the intermediate sections are formed in the region of the hollow section, in which the at least one wheel rim is placed on the hollow section during the fastening to the flange section, i.e., in which the centering of the at least one wheel rim on the hollow section and thus the contact with the hollow section is completed.

In one embodiment of the invention, the wheel hub is a cast part. As a result, the wheel hub is produced with low manufacturing outlay. In particular, after the wheel hub has undergone primary shaping, at least some portions of the wheel hub, preferably an outer side of the hollow section, are fine-machined. In any case, however, the hollow section is machined after the primary shaping of the wheel hub, in order to form the intermediate sections situated between the centering sections.

The invention also relates to a utility vehicle drive axle which has drive shafts, wherein the drive shafts are each coupled to an associated wheel hub of one or more of the above-described variants. The drive shaft is coupled to the associated wheel hub, in particular, via a planetary gear set in each case, the planetary gear set functioning as a wheel hub drive, or as part of a wheel hub drive.

### BRIEF DESCRIPTION OF THE DRAWINGS

One advantageous embodiment of the invention, which is explained in the following, is shown in the drawings, in which:

FIG. 1 shows a sectional view of a portion of a utility vehicle drive axle;

FIG. 2 shows a perspective view of a wheel hub of the utility vehicle drive axle from FIG. 1, according to a preferred embodiment of the invention; and

FIG. 3 shows a sectional view of the wheel hub from FIG. 2.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

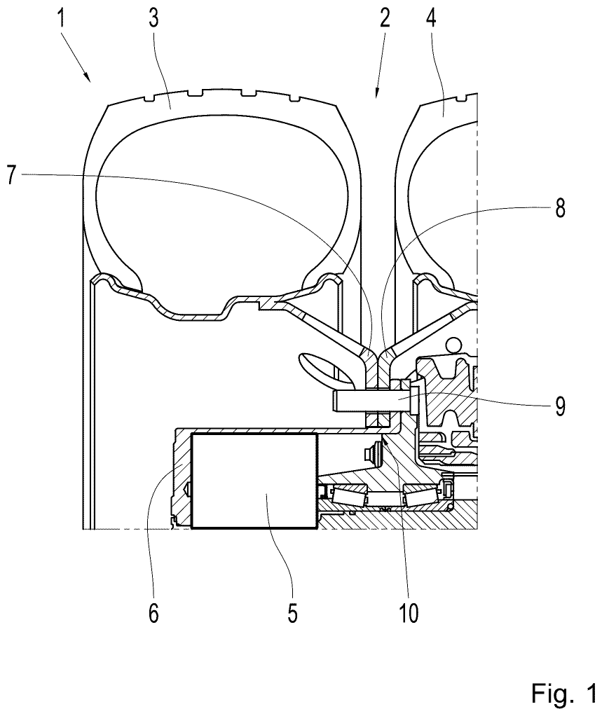

FIG. 1 shows a sectional view of a portion of a commercial, utility vehicle drive axle 1. The utility vehicle drive axle 1 is shown in the region of dual tires 2. In the case of the utility vehicle drive axle 1, driving wheels 3 and 4 of the dual tires 2 are drivable via an associated drive shaft (not shown here), for the purpose of which the drive shaft is coupled via an intermediate wheel hub drive 5 to a wheel hub 6, on which the driving wheels 3 and 4 of the dual tires 2 are mounted by associated wheel rims 7 and 8, respectively. The wheel hub drive 5 is a planetary gear set, which is indicated only in a highly schematic manner in FIG. 1. The driving wheels 3 and 4 are mounted on the wheel hub 6 by their wheel rims 7 and 8 via bolt connections 9 (only one of which is shown), with the wheel rims 7 and 8 being centered on the wheel hub 6 in a region 10.

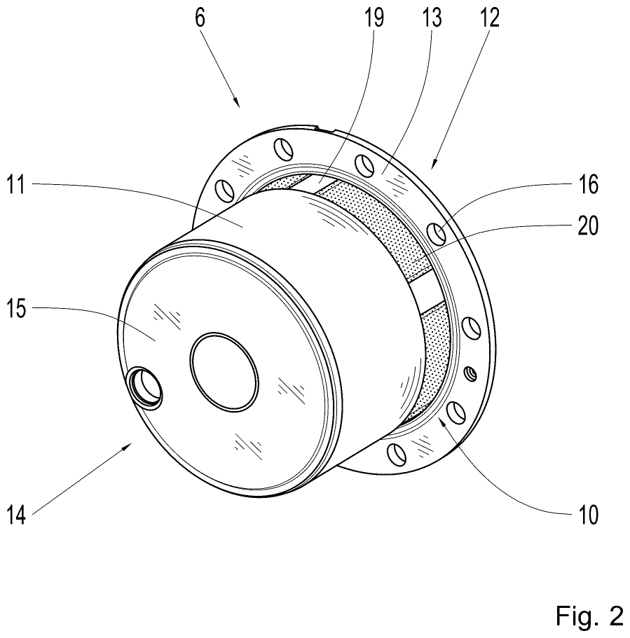

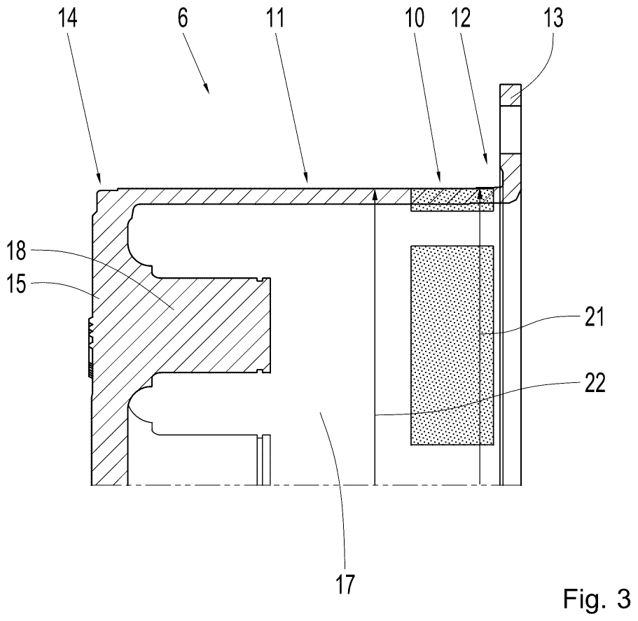

The wheel hub 6 is realized according to a preferred embodiment of the invention and is also shown individually in FIGS. 2 and 3. As is apparent, the wheel hub 6 has or defines a hollow section 11, which transitions at a first axial end 12 into a circumferential flange section 13 and at a second axial end 14 into a base section 15. The hollow section 11 has a substantially hollow cylindrical shape, relative to which the flange section 13 projects radially outwards. Multiple through-holes 16 which are equidistantly spaced apart from one another are introduced into the flange section 13, through which wheel bolts are insertable in order to achieve the bolt connections 9 shown in FIG. 1.

In contrast, the base section 15 extends radially inward from the hollow section 11 and, together with the hollow section 11, delimits an interior 17, in which the wheel hub drive 5 (shown in FIG. 1) is accommodated when the wheel hub 6 is installed. In addition, the base section 15 has projections 18, which project axially into the interior 17 and are provided for guiding one planet gear of the wheel hub drive 5 each. In that respect, the wheel hub 6 is at least a portion of a planet carrier of the wheel hub drive 5.

The region 10 in which the wheel rims 7, 8 are centered on the wheel hub 6 is provided in the region of the first axial end 12 of the hollow section 11 and thus adjacent to the flange section 13. In this region 10, the hollow section 11 is provided with centering sections 19 and intermediate sections 20, which alternate with each other in the circumferential direction in the region 10. Each centering section 19 and the next centering section 19 are separated by an intermediate section 20 arranged therebetween.

By the centering sections 19, a centering outer diameter 21 (part of which is indicated in FIG. 3) of the hollow section 11 is defined. The intermediate sections 20 are radially set back relative to the centering sections 19 and thus are situated on a diameter 22 (part of which is indicated in FIG. 3) which is smaller in comparison to the centering outer diameter 21. As a result, a contact surface of the wheel hub 6 at the hollow section 11 with the wheel rims 7 and 8 centered thereon is reduced, whereby, in the case of corrosion, the wheel rims 7 and 8 are more easily detachable from the wheel hub 6 due to the reduced contact surface. Furthermore, an outer diameter of the hollow section 11 reduces from the region 10, and thus from the centering outer diameter 21, toward the axial end 14.

The wheel hub 6 is a cast part in the present case, and therefore the hollow section 11, the flange section 13, and the base section 15 have been produced within the framework of a primary shaping process. As a distinguishing feature, the intermediate sections 20 between the centering sections 19 are formed after the primary shaping process by machining the hollow section 11, in that material has been removed in the relevant circumferential sections of the hollow section 11 by machining. As a result, the region 10 of the wheel hub 6 having the centering sections 19 and the intermediate sections 20 is therefore formed with low manufacturing outlay.

By the embodiment according to the invention, a wheel hub is obtained with low manufacturing outlay.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 utility vehicle drive axle
2 dual tires
3 driving wheel
4 driving wheel
5 wheel hub drive
6 wheel hub
7 wheel rim
8 wheel rim
9 bolt connections
10 region
11 hollow section
12 axial end
13 flange section
14 axial end
15 base section
16 through-holes
17 interior
18 projections
19 centering sections
20 intermediate sections
21 centering outer diameter
22 diameter

1.-7. (canceled)

8. A wheel hub (6) for a utility vehicle drive axle (1), comprising:
a hollow section (11) extending between a first axial end (12) and a second axial end (14), the hollow section (11) having centering sections (19), the centering sections (19) defining a centering outer diameter (21) of the hollow section (11) for centering at least one wheel rim (7, 8) on the hollow section (11), the centering sections (19) being separated from one another in the circumferential direction by intermediate sections (20), each of the intermediate sections (20) being radially recessed relative to the centering sections (19), the intermediate sections (20) being formed by machining the hollow section (11) between the centering sections (19); and
a flange section (13) transitioning from the first axial end (12) of the hollow section, the flange section (13) projecting radially outwards relative to the hollow section (11), the at least one wheel rim (7, 8) being couplable to the flange section (13).

9. The wheel hub (6) of claim 8, wherein the hollow section (11) transitions at the second axial end (14) into a base section (15), the second axial end (14) being opposite the first axial end (12), the base section (15) extending radially inwardly from the hollow section (11), the hollow section (11) and the base section (15) together delimiting an interior (17).

10. The wheel hub (6) of claim 9, wherein projections (18) are formed on the base section (15) and project axially into the interior (17), each of the projections being configured to guide a respective planet gear of a planetary gear set.

11. The wheel hub (6) of claim 8, wherein an outer diameter of the hollow section (11) decreases from the centering outer diameter (21) toward the second axial end (14), the second axial end (14) being opposite the first axial end (12).

12. The wheel hub (6) of claim 8, wherein the centering sections (19) and the intermediate sections (20) are axially formed in a region (10) on the hollow section (11), the at least one wheel rim (7, 8) being receivable on the hollow section (11) at the region (10) for coupling to the flange section (13).

13. The wheel hub (6) of claim 8, wherein the wheel hub (6) is a cast part, the intermediate sections (20) being formed by machining the hollow section (11) between the centering sections (19) after the wheel hub (6) is cast.

14. A utility vehicle drive axle (1), comprising:
drive shafts, each of the drive shafts being coupled to a respective one of the wheel hub (6) of claim 8.
